(19) United States
(12) Patent Application Publication
(10) Pub. No.: US 2014/0198785 A1
(43) Pub. Date: Jul. 17, 2014

(54) APPARATUS, METHOD AND SYSTEM FOR PROVIDING NEW COMMUNICATION SERVICES OVER EXISTING WIRING

(71) Applicant: Telecom New Zealand Limited, Auckland (NZ)

(72) Inventors: David Hemi Awatere, Waitakere City (NZ); Philip Murray Ivanier, Auckland (NZ); Kevin Maloney, Wellington (NZ)

(73) Assignee: Telecom New Zealand Limited, Auckland (NZ)

(21) Appl. No.: 13/966,022

(22) Filed: Aug. 13, 2013

Related U.S. Application Data
(63) Continuation of application No. 12/666,608, filed on May 16, 2011, now abandoned.
(60) Provisional application No. 60/946,117, filed on Jun. 25, 2007.

(51) Int. Cl. H04M 7/00; H04M 1/253

(52) U.S. Cl. CPC H04M 7/006; H04M 1/2535
USPC 370/352; 379/93.06

(57) ABSTRACT

The invention provides apparatus for providing a next-generation communication system over existing wiring. In one form the apparatus includes an input to receive broadband signals carrying next-generation communication data, a processor to extract the next-generation communication data from the broadband signals and a converter to convert the next-generation communication data into analogue telephone signals. The apparatus is arranged to output the analogue telephone signals at the input of the apparatus. Also described is a related method of providing a next-generation communication system over existing wiring.

### FIELD OF THE INVENTION

The present invention relates to an apparatus, method and system for providing new communication services over existing wiring. In particular, but not exclusively, the present invention relates to an apparatus, method and system using a gateway that can be self-installed without requiring changes to be made to existing wiring for a user to gain access to next-generation communication systems, such as voice-over-internet-protocol (VoIP).

### BACKGROUND TO THE INVENTION

The implementation of a new communication system typically requires significant changes to be made to at least the network-end of the communication system. Significant changes may also need to be made at the user-end of the communication system. Take, for example, voice-over-internet-protocol (VoIP), which relates to technology that allows users to make telephone calls over the internet. To provide VoIP services over conventional Plain Old Telephone Service (POTS) communication systems, various installations, such as those described below, have been proposed.

In FIG. 1, the installation shown includes a conventional POTS exchange 100, which provides conventional telephone services. In use, telephone signals travel down from the exchange 100 via the local loop 102 into existing wiring 104 in a user's premises. The installation also includes a Digital Subscriber Line Access Multiplexer (DSLAM) 106 and a softswitch 108 to provide users with broadband internet access via xDSL (any variety of Digital Subscriber Line). There are also filters 110 provided to selectively filter out the xDSL signals and allow conventional POTS signals through to be received by existing telephones 112.

To provide VoIP services, a gateway 114 is installed at the user's premises. The gateway 114 processes xDSL signals and outputs data signals from port D for non-VoIP internet services, and outputs voice signals from port V for VoIP services. The installation shown in FIG. 1 thus provides two voice lines—one over the conventional POTS system via existing telephones 112, and one using VoIP via gateway 114.

One example gateway is described in US Patent Application No. 2004/0107299 to Lee et al. The gateway described by Lee et al. provides a user with access to a variety of interfaces, such as xDSL, VoIP, Public Switching Telephone Network (PSTN) and Home Phoneline Networking Alliance (HomePNA).

With the recent growth in broadband internet technology and availability, next-generation communication systems, such as VoIP, are increasingly being sought to replace conventional POTS. One current proposal to fully replace a POTS telecommunication system with VoIP is shown in FIG. 2. In this proposal, the POTS exchange 100 from FIG. 1 is removed. Since there is no longer a POTS line, and thus no POTS signal entering the premises, the gateway 114 is placed at the user's premises between the DSLAM 106 and the user's conventional equipment to properly convert the incoming xDSL signals into analogue POTS signals for the conventional telephones 112.

However, the above proposal requires changes to be made to the existing wiring in the user's premises. In particular, to install the gateway of the above proposal, the point of entry of the wiring into the premises must be located, cut and rewired so as to connect to the gateway before connecting to any other equipment in the premises. These steps can be very complicated in practice and, as such, are seldom carried out by an end user to self-install the gateway.

It is an object of the present invention to provide an apparatus, method and system that provide an improved way in which next-generation communication systems may be provided and/or that at least provide the public with a useful choice.

### SUMMARY OF THE INVENTION

In a first aspect, the present invention consists of apparatus for providing a next-generation communication system over existing wiring, the apparatus comprising:
an input to receive broadband signals carrying next-generation communication data;
a processor to extract the next-generation communication data from the broadband signals; and
a converter means to convert the next-generation communication data into analogue telephone signals;
wherein the apparatus is arranged to output the analogue telephone signals at the input of the apparatus.

The term ‘comprising’ as used in this specification means ‘consisting at least in part of, that is to say when interpreting statements in this specification which include that term, the features, prefaced by that term in each statement, all need to be present but other features can also be present.

As used herein the term “and/or” means “and” or “or”, or both.

As used herein “(s)” following a noun means the plural and/or singular forms of the noun.

The invention consists in the foregoing and also envisages constructions of which the following gives examples only.

In a second aspect, the present invention consists of apparatus for providing a next-generation communication system over existing wiring, the apparatus comprising:
a first input to receive broadband signals carrying next-generation communication data;
an output to send the broadband signals from the first input to a gateway to extract the next-generation communication data and convert the next-generation communication data into analogue telephone signals; and
a second input to receive the analogue telephone signals from the gateway;
wherein the apparatus is arranged to output the analogue telephone signals at the first input of the apparatus.

In a third aspect, the present invention consists of a method of providing a next-generation communication system over existing wiring, the method comprising the steps of:
receiving, via an input, broadband signals carrying next-generation communication data;
processing the broadband signals to extract the next-generation communication data;
converting the next-generation communication data into analogue telephone signals; and
outputting the analogue telephone signals at the input.

In a fourth aspect, the present invention consists of a system for providing a next-generation communication system over existing wiring, the system comprising:
a broadband network capable of carrying next-generation communication data; and
one or more next-generation communication apparatus connecting users to the broadband network;
wherein the one or more next-generation communication apparatus are adapted to:
   receive, via an input, broadband signals carrying next-generation communication data;
   process the broadband signals to extract the next-generation communication data;
   convert the next-generation communication data into analogue telephone signals; and
   output the analogue telephone signals at the input.

In a fifth aspect, the present invention consists of a method of providing a next-generation communication system over existing wiring, the method comprising the steps of:
connecting, at a user's premises, the apparatus of the first or second aspect of the invention;
receiving, at a network end, notification of the connection of the apparatus;
disconnecting a conventionally-provided POTS service to the user such that there is no POTS signaling from the network to the user; and
allowing the user to access the next-generation communication system.

The term ‘next-generation communication’ as used in this specification means any communication technology that is or can be adapted for telephonic communication via the internet using internet protocol or the like. Communication using voice-over-internet-protocol or VoIP is one current and non-limiting example of a next-generation communication. The present invention is thus applicable not only to VoIP but also to any communication technology in accordance with the definition of ‘next-generation communication’ noted above.

The term ‘existing wiring’ as used in this specification means wiring that is already installed in at least part of a user's premises for telephonic communication over POTS.

The term ‘broadband’ as used in this specification means any technology that provides high-speed access to the internet. Skilled persons will be familiar with the following broadband technologies currently available, which are listed as non-limiting examples of ‘broadband’ as used in this specification: xDSL (any variant of the Digital Subscriber Line technology, including Asymmetric Digital Subscriber Line (ADSL), High-Bit-Rate Digital Subscriber Line (HDSL) and Rate-Adaptive Digital Subscriber Line (RADSL)), cable and satellite.

In this specification, where reference has been made to patent specifications, other external documents, or other sources of information, this is generally for the purpose of providing a context for discussing the features of the invention. Unless specifically stated otherwise, reference to such external documents or sources of information is not to be construed as an admission that such documents or sources of information in any jurisdiction are prior art, or form part of the common general knowledge in the art.

This invention may also be said broadly to consist in the parts, elements and features referred to or indicated in the specification of the application, individually or collectively, and any or all combinations of any two or more said parts, elements or features. Where specific integers are mentioned herein which have known equivalents in the art to which this invention relates, such known equivalents are deemed to be incorporated herein as if individually set forth.

### BRIEF DESCRIPTION OF THE FIGURES

Preferred forms of the apparatus, method and system of the present invention will now be described with reference to the accompanying figures in which:

FIG. 1 is a block diagram showing a traditional next-generation communication system installation;

FIG. 2 is a block diagram showing a known proposal for a next-generation communication system installation;

FIG. 3 is a block diagram showing one form of the apparatus of the invention;

FIGS. 4A-4C are block diagrams showing the processing of signals by the apparatus of FIG. 3;

FIG. 5 is a block diagram showing another form of the apparatus of the invention;

FIG. 6 is a block diagram showing one form of the system of the invention;

FIG. 7 is a block diagram showing another form of the system of the invention;

FIG. 8 shows a preferred form filter of FIG. 5;

FIG. 9 shows a further preferred form filter of FIGS. 5; and

FIG. 10 is a flowchart showing one form of the method of the invention.

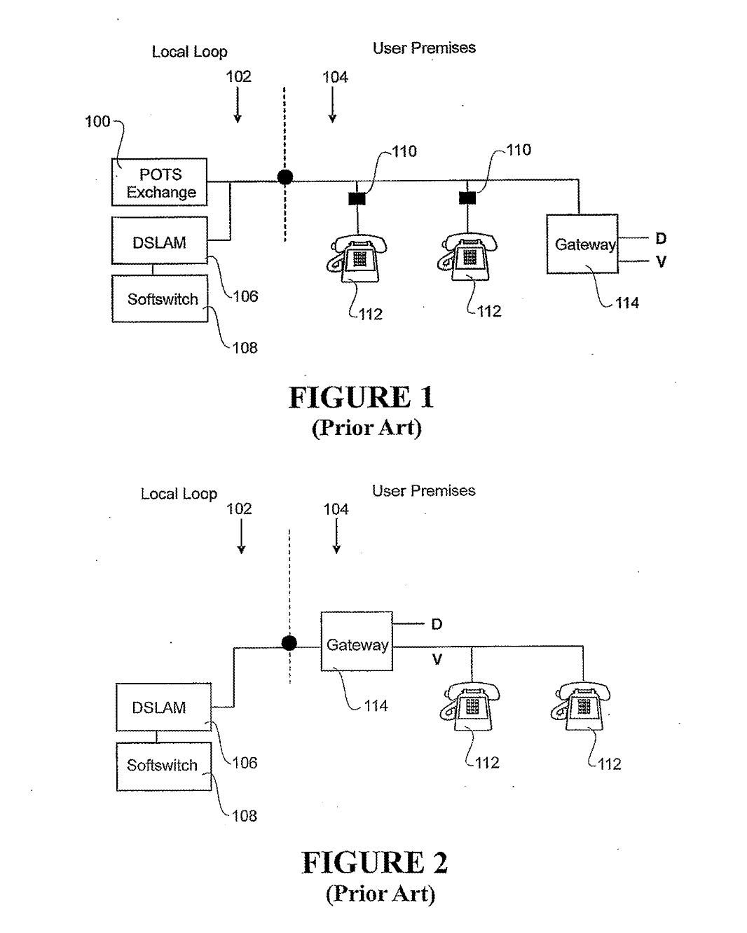

### DETAILED DESCRIPTION OF PREFERRED FORMS

In the preferred forms of the present invention as herein described, a next-generation communication system is provided to a user by allowing the re-using or re-purposing of existing wiring in the user's premises. The re-using or re-purposing of existing wiring brings about two main and interrelated benefits: (i) the ability of a user to self-install required components to adapt existing wiring, and thus existing user equipment, for a next-generation communication system, and (ii) the ability of a telecommunications company to roll-out a next-generation communication system without having to send one or more servicepersons to each user premises to make appropriate changes to existing wiring in the premises to allow a user to gain access to the next-generation communication system.

The preferred ways in which the present invention allows a re-using of existing wiring for a next-generation communication system will now be described with reference to VoIP as the next-generation communication system. As persons skilled in the art will appreciate, other communication systems may be used in addition to or in replacement of VoIP. The description below should therefore not be read as limiting the present invention to VoIP services.

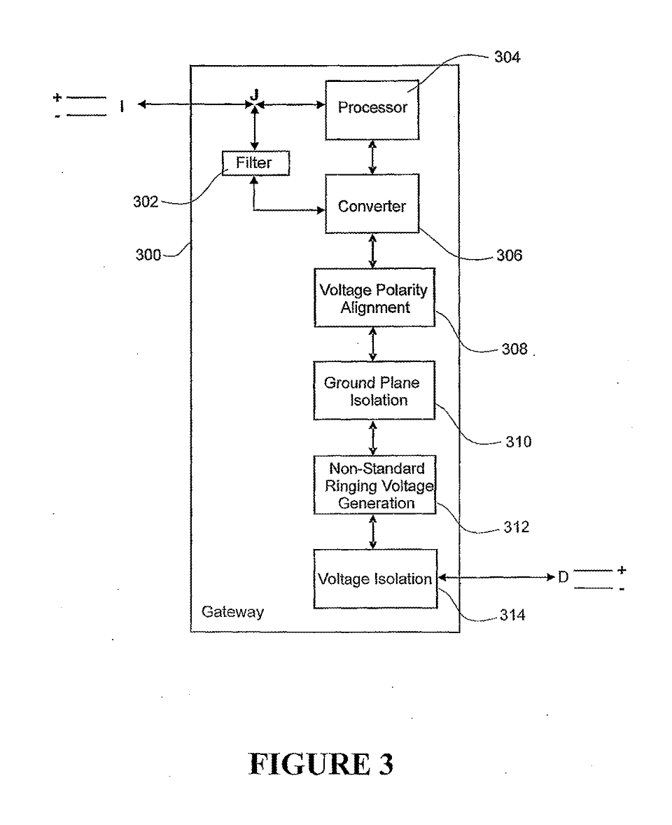

The apparatus of the present invention, in one form, will now be described with reference to FIG. 3. The apparatus is shown in the form of a gateway 300 for providing a next-generation communication system, VoIP for instance, to a user. It is intended that the gateway 300 be inserted into any one of the telephony appliance jacks in a consumer's premises. Delivery of ADSL and telephone services is achieved using the fact that analogue telephony data and broadband data occupy different spectrums (0-3 kHz for analogue telephony and 30 kHz-3 MHz for broadband). The voice telephone system is matched to 600 ohms, while ADSL technology is designed for 100 ohms.

The gateway 300 includes an input I to receive broadband signals carrying next-generation communication data from a network. In the preferred form, the input receives xDSL signals carrying, amongst others, VoIP data via a standard BT Jack, RJ-11, RJ-12, RJ-14 or RJ-45 plug that is plugged into a corresponding telephone jack at a user's premises.

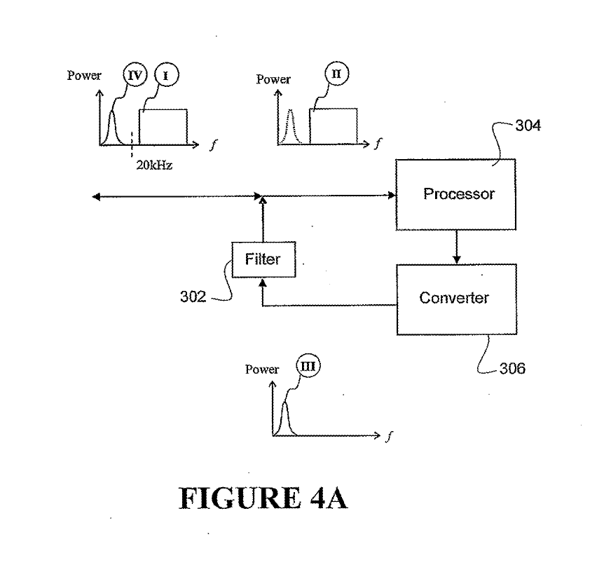

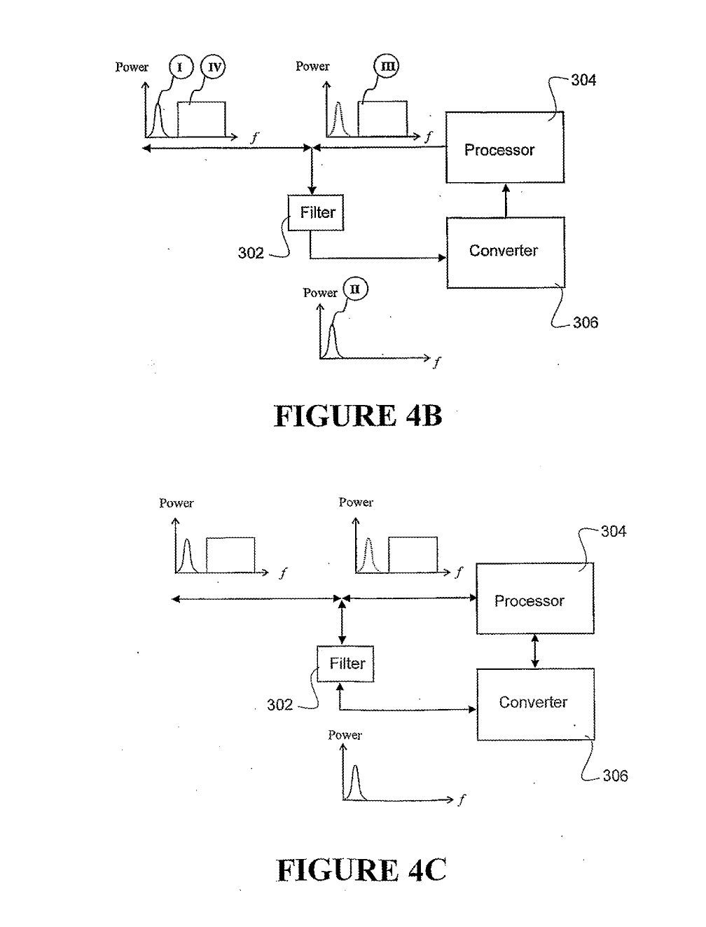

The xDSL signals received at input I are preferably first sent to a processor 304. The main function of the processor 304 is to extract the VoIP data from incoming xDSL signals, and to later incorporate VoIP data into outgoing xDSL signals. In the preferred form, the processor 304 is a conventional modem device that demodulates the incoming xDSL signals, and modulates the outgoing xDSL signals. The demodulation using the modem device produces data signals at port D that may be used by a computer or like device, similar to conventional DSL modems. The demodulation also produces VoIP data that are sent to a converting means 306. The modulation using the modem device will be described later with reference to FIGS. 4A to 4C.

A converting means or converter 306, in the preferred form, is a conventional Analogue Telephone Adapter (ATA). The function of the converting means is to suitably convert digital signals, which represent VoIP data coming in from the processor 304, to analogue telephone signals to be received by conventional telephones, and vice versa.

In the preferred form of the present invention, the analogue telephone signals produced by the converting means 306 are sent to a filtering means or filter 302. The filtering means 302 is designed to substantially shield the converting means 306 from incoming xDSL signals, where intermodulation of signals may be a problem in the user's premises. Normally, signals of different frequencies can be present on the same wiring without interfering with each other. However, if there are non-linear devices connected to the wiring, the signals of different frequencies may intermodulate with each other, and with themselves. This can result in audible noises over conventional telephones in the premises. Non-linear, in the above context, means that the output signals of the device are not directly proportional to the input signals. As some converting means 306 may have non-linear properties, the placement of a filtering means 302 adjacent the converting means 306 may prevent intermodulation from occurring. If the processor 304 is also likely to have non-linear properties, the filtering means 302 may be adapted and moved to the joining point, J.

In the simplest form of the present invention, a filtering means is not required. In a preferred form, as described above, the present invention includes a filtering means to prevent intermodulation and to aid in splitting and combining signals in the apparatus. In the preferred form, the filtering means filters out high frequency components and only allows low frequency components to enter the converting means. The filtering means may also divert high frequency components to the processor. The filtering means may be a passive (unpowered) device made from a network of capacitors, resistors and inductors. Alternatively, the filtering means may be an active device (incorporating amplifiers), or even a digital device. It should be noted that, if the converting means has been designed to be immune to intermodulation, the filtering means will not be required and will be replaced with a combination-and-splitting point for the signals.

In some installations the line entering the user's premises has an associated voltage. This is shown by the positive and negative lines at the input I. One difficulty with an input that has an associated voltage is that there are no standard requirements for labelling the wiring from other parts of the network to the user's premises. The effect of this is that there is the potential for a user to connect the gateway in an incorrect manner.

One embodiment of the gateway 300 includes further components to deal with the above problem. These include a voltage polarity alignment component 308, a ground plane isolation component 310, a non-standard ringing voltage generation component 312 and a voltage isolation component 314. These four components are preferably integrated into the gateway 300 so that they are available if there is an associated voltage with the input line.

The voltage plurality alignment component 308 comprises a circuit to automatically align the positive lines and negatives lines from other parts of the network to the user's premises. This circuit is ideally activated every time the gateway is reconnected to the network.

The ground plane isolation component 310 ensures that the ground plane in the gateway 300 between other parts of the network is isolated.

Non-standard ringing voltage generation component 312 deals with increasing voltages generated by the gateway 300. One possible solution is a component that generates a unique sine wave verses a standard ring signal.

Voltage isolation component 314 comprises circuitry to isolate any high voltage areas of the gateway 300.

One alternative to above components 308, 310, 312 and 314 is to ensure that each line entering a user premises does not include a voltage. In some networks this can be achieved by pulling a jumper pin at the exchange. This is manually intensive. A more elegant solution is to include components 308, 310, 312 and 314 in gateway 300.

An example operation of the apparatus of FIG. 3 will now be described with reference to FIGS. 4A to 4C. FIG. 4A shows a schematic of signal bandwidths representing the signals in the apparatus from the point where incoming broadband signals are received by the apparatus from the network to the point where analogue voice signals are outputted by the apparatus. FIG. 4B shows a schematic of signals bandwidths representing the signals in the apparatus from the point where analogue voice signals are received by the apparatus from the conventional telephones in the premises to the point where broadband signals are outputted from the apparatus to the network. These figures each represent half of the operation of the apparatus. The full duplex operation is shown in FIG. 4C.

In FIG. 4A, incoming xDSL signals, labelled as I, are received at an input in the apparatus. The signals are then sent, as signals II, to the processor 304 for next-generation data extraction. Relevant data are forwarded to converting means 306 to be converted into analogue telephone signals, labelled as III. The analogue telephone signals are then outputted at the input, as signals IV, for reception by conventional telephones over existing wiring. As shown in phantom, the analogue telephone signals may also be sent to the processor 304 for rejection or distribution to equipment connected to the processor 304.

In FIG. 4B, incoming analogue telephone signals, labelled as I, coming in from the user's conventional telephone, are received at the input of the apparatus. The signals are sent, as signals II, to the converting means 306 to be converted into VoIP data, for example. The data are then sent to the processor 304 to adapt the data for, or incorporate the data into, xDSL signals, labelled III. The xDSL signals are then outputted to the network as signals IV.

The combination of the half duplex operations into a full duplex operation is shown in FIG. 4C. As shown in the figure, there is bi-directionality of signals for each component of the apparatus for the full duplex operation. The operations described above for FIGS. 4A and 4B are applicable to, and are thus reiterated for, FIG. 4C.

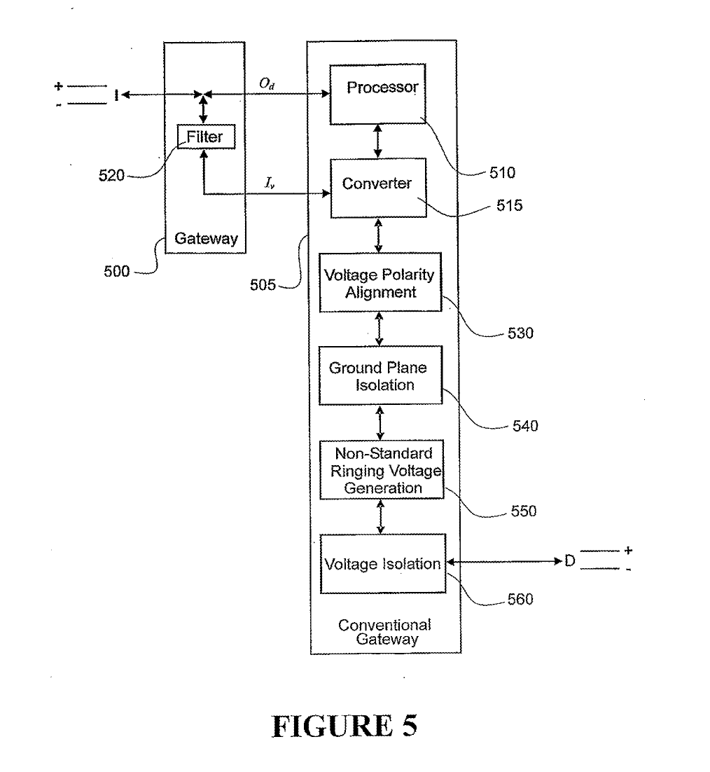

Another form of the apparatus of the present invention is shown in FIG. 5. Here, the apparatus of the invention is a gateway apparatus 500 that is shown connected to a conventional gateway 505. As will be known to skilled persons, there are a variety of conventional gateways for VoIP services that come complete with a processor 510, such as a modem, and a converting means 515, such as an ATA. One example gateway is the HomePortal gateway supplied by 2wire (www.2wire.com). To implement the functions of the gateway 300 of FIG. 3, the gateway apparatus 500 need only be provided with suitable inputs, outputs and an optional filtering means 520, and be connected to a conventional gateway 505 as shown in the figure.

As with the gateway 300, the gateway apparatus 500 includes an input I to receive broadband signals, preferably xDSL signals, carrying VoIP data. The xDSL signals are passed to a data input, such as a Wide Area Network (WAN) socket, of a conventional gateway 505. The gateway 505 then processes the xDSL signals in the manner described with reference to FIG. 3 earlier and outputs analogue telephone signals to a second input, Iᵥ, of the gateway apparatus 500. The filtering means 520 then passes the analogue telephone signals to the input I. Examples of a suitable filtering means are described below.

As shown in FIG. 5 one preferred form gateway 505 is modified to include a voltage polarity alignment component 530, ground plane isolation component 540, non-standard ringing voltage generation component 550 and voltage isolation component 560. Components 530, 540, 550 and 560 function in a similar manner and have a similar purpose to respective components 308, 310, 312 and 314 described above with reference to FIG. 3.

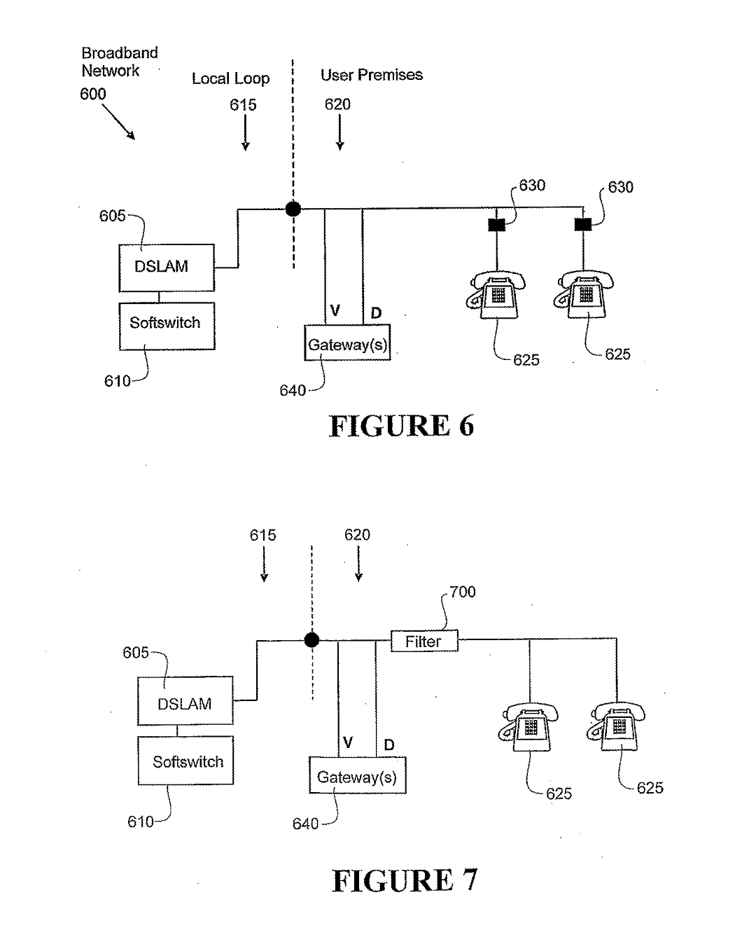

Referring to FIG. 6, a preferred form system of the present invention will now be described with reference to VoIP as the next-generation communication system. As noted earlier, the present invention should not be limited to VoIP since any next-generation communication system that is in accordance with the definition provided earlier can be used instead of VoIP.

The preferred form system includes a broadband network 600 capable of carrying VoIP data. In the preferred form, the network 600 is an xDSL network with a DSLAM 605 and softswitch 610 connected to a local loop 615 for providing DSL services to users connected to the local loop 615. A user is shown connected to the local loop via existing home wiring in a user premises 620. Connected to the home wiring are conventional telephones 625 to which filters 630 are coupled to prevent high-frequency DSL signals from being received by the telephones 625.

The system also includes a VoIP apparatus 640. The apparatus 640 can be either the gateway 300 of FIG. 3, or a combination of the gateway apparatus 500 and the gateway 505 of FIG. 5. As previously described, the gateway outputs analogue telephone signals on the input through which it receives xDSL signals. This results in the user's existing home wiring carrying both xDSL signals from the network and analogue telephone signals from the apparatus 640. The benefit of this result is that the apparatus 640 can be connected downstream of the user's existing wiring and still be capable of providing the user with conventional telephone services via devices upstream of the apparatus 640. Therefore, to gain access to VoIP services via existing telephones, the user only needs to plug the apparatus 640 into a telephone jack somewhere in the user's premises. This can be contrasted with the requirement of prior art systems of placing the apparatus at the entry of xDSL signals into the premises.

The system of FIG. 6 shows the installation of the apparatus 640 in a user's premises where DSL access equipment have been installed in a particular arrangement. In particular, the individual filters 630 have been coupled adjacent the conventional telephones 625.

In another arrangement, the user's premises is provided with a single filter connected upstream of all conventional telephones. The single filter is shown as 700 in FIG. 7. In this installation, the apparatus 640 is connected upstream of the filter 700 so as to have access to unfiltered incoming DSL signals.

In one embodiment the gateway(s) 640 of FIG. 6 and/or FIG. 7 includes smart sensing functionality. As previously described, the gateway(s) 640 includes an input through which it receives xDSL signals. The gateway 640 further monitors voltage on the input line. If it detects voltage provided by the POTS Signal then the gateway 640 outputs PSTN analogue telephone signals on the input through which it receives xDSL signals.

Where the gateway 640 no longer detects voltage it switches to VoIP mode. Instead of PSTN analogue telephone signals the gateway 640 outputs VoIP data on the xDSL network. The gateway 640 supplies telephones 625 with PSTN voltage and dial tone. The gateway 640 receives as input PSTN analogue telephone signals, converts these signals to VoIP and sends the signals up the network.

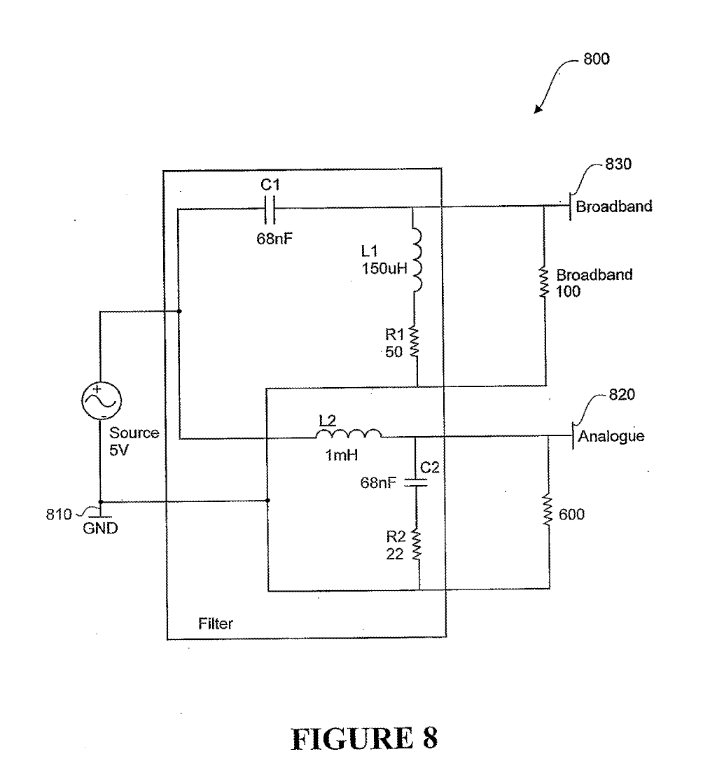

FIG. 8 shows one example of filter 520 described above with reference to FIG. 5. Filter 800 is intended to split analogue and digital frequencies with a low pass and a high pass filter respectively. The filter is also ideally designed to match impedances for a wide variety of cable conditions.

The preferred form filter 800 includes a low pass filter for analogue telephony data and a high pass filter for broadband data. The filter 800 has a single input 810 and separate outputs for analogue telephony 820 and broadband data 830. The cut off frequency for the analogue telephony data filter is 10 kHz and for the broadband filter is 50 kHz.

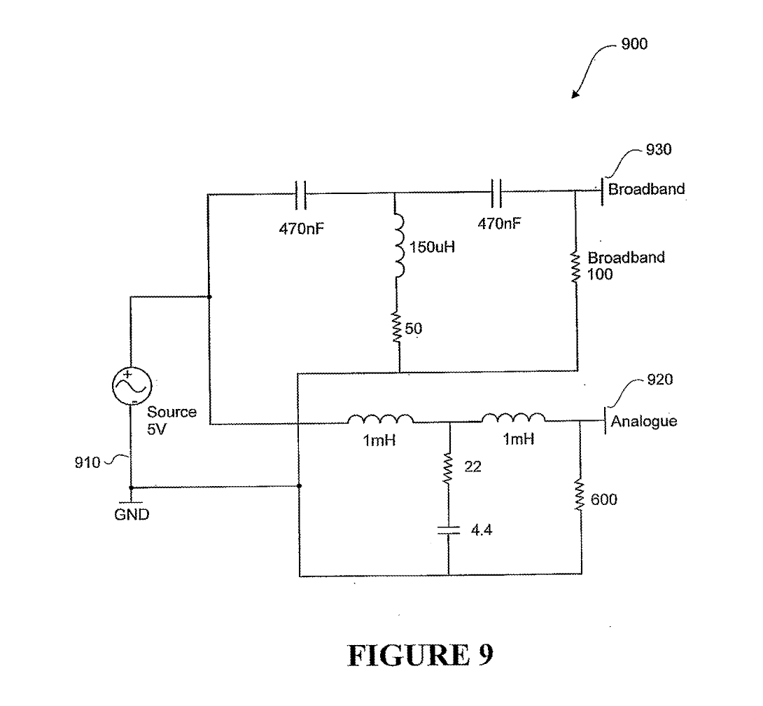

FIG. 9 shows an alternative filter 900. The filter has a single input 910 and separate analogue 920 and broadband 930 outputs. The cut off frequency of filter 900 is 4.8 kHz for the analogue telephony data filter and for the broadband filter is 10 kHz. The benefit of filter 900 is that it is symmetric. It is desirable that the transfer function of the filter is the same in both directions to accommodate upstream and downstream analogue telephony data. A symmetric filter facilitates transfer in both directions.

Instead of using the apparatus and system of the invention as described earlier, skilled persons may choose to implement the method of the invention. In this way, skilled persons may implement the present invention in any manner that is suitable to their needs and/or suitable in view of the available technology.

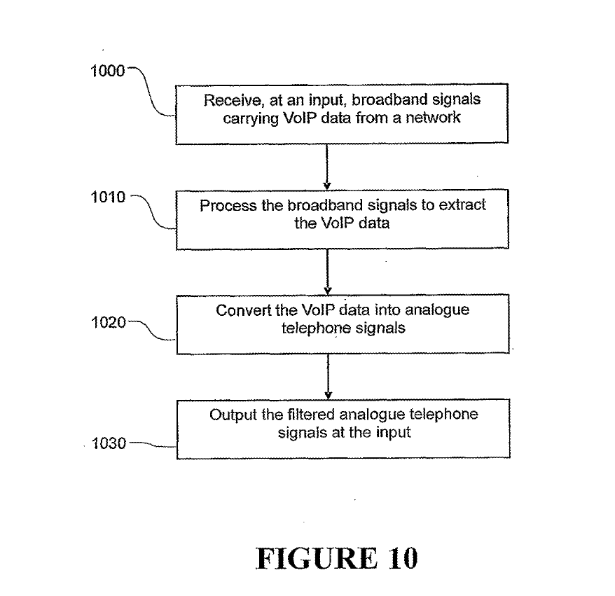

One form of the method of the present invention is shown in the flowchart of FIG. 10. As with the description for the apparatus and system of the present invention, the method of the present invention will be described with reference to VoIP as a non-limiting example of a next-generation communication system to which the present invention applies.

The method begins in step 1000 where broadband signals carrying VoIP data from a network are received at an input. In step 1010, the broadband signals are processed to extract the VoIP data. In step 1020, the extracted VoIP data are converted into analogue telephone signals. The analogue telephone signals are then outputted through the input in step 1030. This method corresponds to the processes described in relation to FIG. 4A. Persons skilled in the art will readily appreciate that the preferred form method could be adapted to also provide for the processes described in relation to FIG. 4B.

Although the above method is described with reference to discrete steps being carried out, it is possible and even desirable in some cases to combine and carry out some of the steps together. It is also possible to carry out some steps in an order different to that shown in FIG. 10. For instance, the extraction of VoIP data and the conversion of the same into analogue telephone signals, shown as steps 1010 and 1020 in FIG. 10, may be simultaneously carried out by some form of digital signal processor.

The present invention provides end users with the benefit of being able to self-install the required components for access to next-generation communication systems. For instance, once a user purchases either the integrated gateway shown in FIG. 3 or the separate gateway and gateway apparatus shown in FIG. 5, the user only needs to plug the gateway or apparatus into an existing socket in the premises to physically install the same. Further, because the present invention adapts existing wiring and, as such, existing equipment for use with the next-generation communication systems, end users using the present invention will be able to seamlessly upgrade the conventional communication system in the premises to a next-generation communication system.

The benefit of the present invention also extends to telecommunications companies. The corollary of prior art techniques to update networks to a next-generation communication system, where self-installation of the required components is difficult, is that it can be difficult to carry out a large-scale network upgrade. This is because the telecommunications companies must send qualified technicians to each premises to install the required components at the user's premises. By allowing a re-using or re-purposing of existing wiring, a seamless and simple installation of the gateway by the user is made possible by the present invention. This obviates the need for qualified technicians to intervene during installation, and thus makes large-scale network upgrades more realisable than would otherwise be the case if prior art techniques were used.

The present invention also allows a gradual uptake of next-generation communication systems by users and a gradual removal of POTS by the telecommunications companies. For example, for each user that gains access to a next-generation communication system using the present invention, the telecommunications company may disable the POTS connection to the user's premises.

The preferred form of the present invention requires that the conventionally-provided POTS service to be disconnected such that there is no POTS signalling being sent to a user from the network once it is known that the user has put the present invention into effect. In one form, a telecommunications company may automatically detect the installation of an apparatus of the present invention at a user's premises. Alternatively, once the apparatus is installed, the user may be required to call the company's helpdesk or contact the company in some other way to activate a next-generation communication system and, at the same time, notify the company that a full POTS service is no longer required for the premises.

An example process for the above will now be described. As a first step, the apparatus of the present invention will be connected at a user's premises. Once connected, the network end will need to be notified of the connection. This may be done automatically by the apparatus, or by the user providing a manual notification to the network. Once notified, the network end causes the conventionally-provided POTS service to the user to enter a ‘high and dry state’, in which no POTS signaling is sent down to the user. Once this is done, the user is provided with access to the next-generation communication system.

In terms of configuration of the apparatus, the user may have existing or preconfigured setup configuration stored in the network. In this form, an auto-configuration process might occur via broadband signals. In DSL, this is most likely triggered from an auto-configuration server (ACS). Where the user has no existing or preconfigured DSL service, the configuration process may be triggered by the user or the apparatus dialing a special number.

The foregoing describes the invention including preferred forms thereof. Alterations and modifications as will be obvious to those skilled in the art are intended to be incorporated within the scope hereof, as defined by the accompanying claims. For instance, while the figures show discrete and separated components for the apparatus of the invention, it is envisaged that the components could be selectively or wholly incorporated together into one component.

1. Apparatus for providing a next-generation communication system over existing wiring, the apparatus comprising:
an input to receive broadband signals carrying next-generation communication data;
a processor to extract the next-generation communication data from the broadband signals; and
a converter to convert the next-generation communication data into analogue telephone signals;
wherein the apparatus is arranged to output the analogue telephone signals at the input of the apparatus.

2. The apparatus of claim 1 wherein the input also receives analogue telephone signals, with the converter being arranged to convert the analogue telephone signals into next-generation communication data, and with the processor being adapted to produce broadband signals containing the next-generation communication data to be outputted at the input.

3. The apparatus of claim 1 further comprising a filter coupled to the input and the converter.

4. The apparatus of claim 3 wherein the filter is further coupled to the processor.

5. The apparatus of claim 1 wherein the next-generation communication system is a voice-over-internet-protocol (VoIP) communication system.

6. The apparatus of claim 1 wherein the processor is a modem.

7. The apparatus of claim 1 wherein the converter is an Analogue Telephone Adapter (ATA).

8. The apparatus of claim 1 wherein the filter also filters the broadband signals received by the apparatus.

9. Apparatus for providing a next-generation communication system over existing wiring, the apparatus comprising:
a first input to receive broadband signals carrying next-generation communication data;
a voltage polarity alignment component configured to align positive and negative lines at the first input where there is an associated voltage;
an output to send the broadband signals from the first input to a gateway to extract the next-generation communication data and convert the next-generation communication data into analogue telephone signals; and
a second input to receive the analogue telephone signals from the gateway;
wherein the apparatus is configured to selectively output either the analogue telephone signals or the next-generation communication data at the first input of the apparatus on detecting voltage at the first input.

10. The apparatus of claim 9 wherein the first input also receives analogue telephone signals, with the second input being arranged to output the analogue telephone signals to the gateway to be converted into next-generation communication data to be contained in broadband signals, wherein the output of the apparatus is arranged to receive broadband signals from the gateway and to output the broadband signals at the first input.

11. The apparatus of claim 9 further comprising a filter coupled to the first input and the second input.

12. The apparatus of claim 11 wherein the filter is further coupled to the output.

13. A method of providing a next-generation communication system over existing wiring, the method comprising:
receiving, via an input, broadband signals carrying next-generation communication data;
processing the broadband signals to extract the next-generation communication data;
converting the next-generation communication data into analogue telephone signals; and
outputting the analogue telephone signals at the input.

14. The method of claim 13 further comprising:
receiving analogue telephone signals at the input;
converting the analogue telephone signals into next-generation communication data;
processing the next-generation communication data to generate broadband signals containing the next-generation communication data; and
outputting the broadband signals at the input.

15. The method of claim 13 wherein the step of processing the broadband signals comprises demodulating the broadband signals.

16. A system for providing a next-generation communication system over existing wiring, the system comprising:
a broadband network capable of carrying next-generation communication data; and
one or more next-generation communication apparatus connecting users to the broadband network;
wherein the one or more next-generation communication apparatus are adapted to:
receive, via an input, broadband signals carrying next-generation communication data;
process the broadband signals to extract the next-generation communication data;
convert the next-generation communication data into analogue telephone signals; and
output the analogue telephone signals at the input.

17. The system of claim 16 wherein the one or more next-generation communication apparatus are also adapted to:
receive, at the input, analogue telephone signals;
convert the analogue telephone signals into next-generation communication data;
process the next-generation communication data to generate broadband signals containing the next-generation communication data; and
output the broadband signals at the input.

18. A method of providing a next-generation communication system over existing wiring, the method comprising:
connecting, at a user's premises, an apparatus to provide access to a next-generation communication system, the apparatus including:
a first input to receive broadband signals carrying next-generation communication data;
a voltage polarity alignment component configured to align positive and negative lines at the first input where there is an associated voltage;
an output to send the broadband signals from the first input to a gateway to extract the next-generation communication data and convert the next-generation communication data into analogue telephone signals; and
a second input to receive the analogue telephone signals from the gateway;
receiving, at a network end, notification of the connection of the apparatus;
disconnecting a conventionally-provided POTS service to the user such that there is no POTS signaling from the network to the user;
selectively outputting either the analogue telephone signals or the next-generation communication data at the first input of the apparatus on detecting voltage at the first input; and
allowing the user to access the next-generation communication system.

19. The method of claim 18 wherein the apparatus automatically sends the notification to the network end.

20. The method of claim 19 wherein the network automatically records the notification from the apparatus.

21. The method of claim 19 wherein an operator at the network end manually carries out the disconnecting and allowing steps.

22. The method of claim 21 wherein the operator carries out the disconnecting and/or allowing steps at the same time that the network records the notification.

23. The method of claim 21 wherein the operator carries out the disconnecting and/or allowing steps after the network records the notification.

24. The method of claim 21 wherein the user manually sends the notification to the network end.

25. The apparatus of claim 9 wherein the voltage polarity alignment component is configured to be activated on connection to the existing wiring.

26. The apparatus of claim 9 further comprising a ground plane isolation component configured to ensure that a ground plane in the apparatus between other parts of the existing wiring is located.

27. The apparatus of claim 9 further comprising a non-standard ringing voltage generation component configured to generate a unique sine wave.

28. The apparatus of claim 9 further comprising a voltage isolation component configured to isolate high voltage areas of the apparatus.

29. The apparatus of claim 9 wherein the apparatus is configured to output the analogue telephone signals at the first input of the apparatus on detecting voltage at the first input.

30. The apparatus of claim 9 wherein the apparatus is configured to output the next-generation communication data at the first input of the apparatus on detecting no voltage at the first input.

31. The method of claim 18 further comprising outputting the analogue telephone signals at the first input of the apparatus on detecting voltage at the first input.

32. The method of claim 18 further comprising outputting the next-generation communication data at the first input of the apparatus on detecting no voltage at the first input.
